(19) United States
(12) Patent Application Publication
(10) Pub. No.: US 2003/0129735 A1
(43) Pub. Date: Jul. 10, 2003

(54) Biocatalytic method for remediation of soil, water and air.

(76) Inventor: Elliot I. Moorhead, Aptos, CA (US)

Correspondence Address: Jeffrey A. Hall, 212 Clinton Street, Santa Cruz, CA, 95062, US

(21) Appl. No.: 10/041,209

(22) Filed: Jan. 8, 2002

(51) Int. Cl. C12S 1/00

(52) U.S. Cl. 435/262.5

(57) ABSTRACT

A biocatalytic method for remediation and reconditioning of contaminated soil, water, and air, comprising introducing an enzymatic blend for cleaving molecular bonds of contaminants in the soil, water, or air. The enzymatic blend being applied in a gaseous phase and being capable of dispersion through the soil, water, or air. A mixed microbial population for degradation and digestion of the contaminants in the soil, water, or air is also applied in a gaseous phase to the soil, water or air being treated.

### BACKGROUND OF THE INVENTION

1. Field of Invention

The present invention relates to processes and apparatuses for reconditioning soil, water, and air contaminated by volatile organic compounds, hydrocarbons, and other contaminants, and more particularly to a process where a enzymatic blend and a mixed microbial population is introduced to the contaminated area in a gas phase.

2. Description of Prior Art

Contamination of soil, water, and air by various contaminants such as volatile organic compounds (VOC), short chain hydrocarbons, medium chain hydrocarbons, long chain hydrocarbons and other molecular classes is recognized as a serious problem of national and international significance. Heretofore, a number of methodologies and apparatuses have been proposed and implemented to address such contamination.

An example of such environmental contamination was the discovery of serious groundwater contamination in the early 1980's from leaking underground storage tanks (UST's). The problem of contamination of the environment from such leaks and spills was elevated to national prominence. The resulting Environmental Protection Agency (EPA) regulations have been augmented and in many cases superseded by more stringent state and local regulations. Owners of UST's have been required to report to the EPA or local regulators the existence and status of UST's, provide proof that the UST is not leaking, and provide ongoing monitoring to prove the continued security of the installation.

Such programs have resulted in the discovery that as many as 35 per cent of the UST installations which are over 30 years old have been found to be leaking. Contaminated soils the universal result, and contamination of shallow groundwater ubiquitous but somewhat less common.

Many other examples could be presented, however, the vast majority of contamination of soil, water and air, involve volatile organic compounds, and hydrocarbons, such as involve hydrocarbon fuels, most commonly gasoline and diesel fuel, pesticides, insecticides, and the like. Less frequently, hydrocarbon solvents are involved including alcohol's, ketones and chlorinated hydrocarbons. Treatment of contaminated soil, water, and air, is expensive, time consuming, and often a dangerous undertaking. For example, in the US and most other countries, contaminated soil must be treated or disposed of according to Federal and local regulations. Disposal must be at a class 1 landfill at a current cost of about $350 per yard and has the decided disadvantage of accruing to the owner a perpetual liability for the dumpsite.

On site treatment of soils, water, and air, has been accomplished using aeration, bioremediation, incineration, filtration, soil vapor extraction (SVE), and sparging. Aeration consist of exposing contaminated soil to the air with frequent turning. Volatile components are thereby evaporated into the air. This method of treatment is limited in application to volatile contaminants such as gasoline and some solvents. The cost of such method is minimal, but the treatment takes considerable time, typically from 2 to 9 months. Increasingly, this method of treatment is seen as a source of air pollutants and is becoming highly regulated in many areas. Air permits and restrictions add at least 6 weeks time and additional costs to the process. Aeration has been effectively prohibited in some areas.

Another genre of treatment methodologies involve the incineration of contaminated soil using portable combustion units. Although treatment is reported to be both fast and nearly complete the cost of incineration is high, above $200 per yard. A further disadvantage is that air permits must be obtained at each installation before use, requiring six weeks minimum time.

Bioremediation has been practiced for some time in various ways including soil vapor extraction (SVE) and sparging. In its simplest form, where space and time are not limiting, native microorganisms are encouraged to digest the VOC hydrocarbons by aerations and addition of moisture and nutrients. In the most advanced applications of this technique, soil is carefully placed in windows irrigated from above and drained below by perforated pipe. Nutrients and a culture of specially selected microorganisms are continuously supplied to the soil from a bioreactor. The cost of such bioremediation varies considerably, depending on the sophistication of the installation. Costs of more sophisticated systems range above $3000 per yard. Time of treatment varies with the application and sophistication. Typically, treatment may take form 4-18 months for the simplest systems and from 2-6 months for the more elaborate installations. Bioremediation is effective on most hydrocarbons and many solvents, but cannot be used where the soil is contaminated with heavy metals, some pesticides, and other highly biotoxic materials. Soil vapor extraction (SVE) is a method where the contaminant is separated from the soil by negative pressure in vapor form. Sparging is where air is forced into solid or water, and by applying pressure, contaminates are pulled to the surface as a vapor or gas. Often air injection wells are used to increase airflow through the system. Used together combined soil vapor extraction (SVE) and air sparging system have been used for removal and remediation of contaminants in saturated zones of the soil, however, such systems are most effective at sites with coarse-grained soil, such as sand or gravel.

There is considerable variations among contaminated sites, in size, in contaminants present, access, etc., but in most cases economic use of the property is seriously impaired by a finding of contaminated soil. Real estate transactions may be halted and current uses of the property may be hampered or even stopped. In these cases, loss of beneficial use of the property may dwarf the cleanup cost.

There is a very great need for a process and apparatus for rapid and economical soil, water, and air treatment. For example, prior art disposal techniques of contaminated soil at a Class 1 dumpsite are very expensive, and leave the owner with an ongoing exposure to liability. Prior art soil treatment processes take from 2 to 12 months to complete and at very high costs. Prior art incineration techniques require a minimum of 7 weeks to complete and air permits prior to operation. The time and expense of existing treatment methods is significant, and when added to the economic loss of use of the property, the total cost of a soil contamination incident is very substantial.

Accordingly, the primary object of the present invention is to provide a novel and highly efficient biocatalytic method and associated apparatus for the rapid remediation of contaminated soil, water, and air. The method of the present invention may be used for removing and treating volatile organic compounds (VOC), hydrocarbons, and other adsorbed contaminants in the soil, water, or air.

### SUMMARY OF THE INVENTION

To achieve the foregoing objects, and in accordance with the purpose of the invention as embodied and broadly described herein, a biocatalytic method for remediation and reconditioning of contaminated soil, water, and air, is provided comprising introducing an enzymatic blend for cleaving molecular bonds of contaminants in the soil, water, or air. The enzymatic blend is applied in a gaseous phase and is capable of rapid dispersion through the soil, water, or air. A mixed microbial population for degradation and digestion of the contaminants in the soil, water, or air is also applied in a gaseous phase.

### BRIEF DESCRIPTION OF DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a schematic illustration of a illustration of the biocatalytic method of the present invention used in combination with a combined soil vapor extraction and air sparging system, according to the invention.

FIG. 2, is a schematic illustration of such methodology used with a gas phase enzymatic and microbial reservoir operably linked to air pump means for introduction to a contaminated area, according to the invention.

FIG. 3, is a schematic illustration of such methodology used with a vent to suction off gasses, such as volatile organic compounds for treatment, according to the invention.

### DESCRIPTION OF THE PREFERRED EMBODIMENTS

Reference will now be made in detail to the present preferred embodiments of the invention as illustrated in the accompanying drawings.

In accordance with the present invention, there is provided in a preferred embodiment of the invention, a rapid and highly efficient biocatalytic method for remediation and reconditioning of contaminated soil, water, and air, comprising introducing an enzymatic mix for cleaving molecular bonds of contaminants in the soil, water, or air. The enzymatic mix is applied in a gaseous phase and being capable of dispersion through the soil, water, or air. A blended microbial population for degradation and digestion of the contaminants in the soil, water, or air is also applied, preferably in a gaseous phase to the soil, water or air being treated.

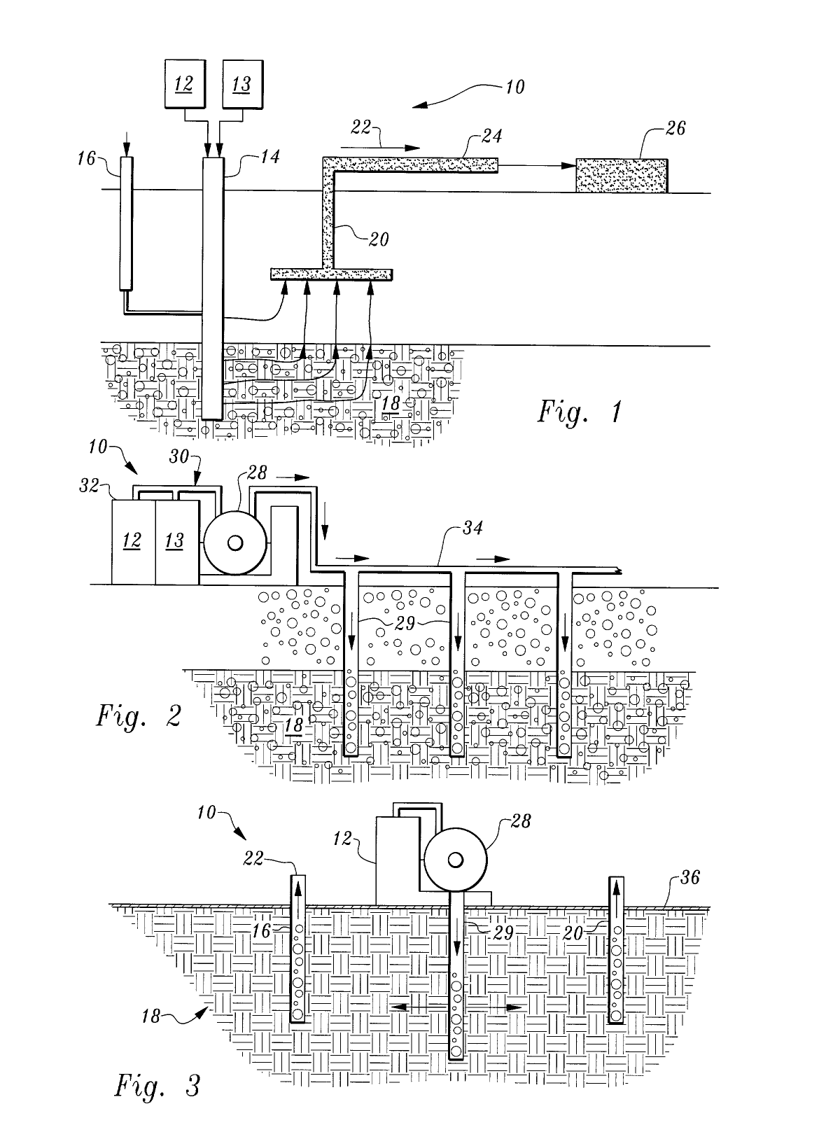

In FIG. 1, the biocatalytic method 10, of the present invention is shown being applied in a combined soil vapor extraction (SVE) and air sparging system. Method 10, preferably comprises the introduction or injection of enzymatic means 12 and microbial means 13, for cleaving molecular bonds of contaminants in treatment area 18, which may be soil, water, or air. Both enzymatic and microbial means 12 and 13, are preferably applied in a gaseous phase and being capable of dispersion through the soil, water, or air. However, in alternative embodiments, the enzymatic and microbial means may be applied as a fluid, semi-solid, or solid. Preferably, the enzymatic means 12, and microbial means 13, are applied in a gaseous phase at ambient temperature.

In the preferred embodiment, enzymatic means 12, comprise a blend enzymes comprising lipase, amylase, protease, cellulase, and pectinase. The enzymatic blend is specifically designed to catalyze the rapid breakdown of short, intermediate, and long chain hydrocarbons, as well as other contaminating molecules into shorter chain molecules making them available for digestion by the specifically selected microbial mix. In general terms, the enzymatic action is based on the cleaving of covalent molecular bonds so as to create more nutritionally accessible compounds for biodegradation by the introduced microbial mix, and by indigenous microbial species.

Microbial means 13, preferably comprise a microbial mix of bacillus megaterium, bacillus licheniformis, bacillus subtilis, bacillus thuringenis, and polymyxa. Preferably, this selected and blended mix of facultative bacterium are used to rapidly digest contaminants in liquid, solid or gas phase. Using the method of the present invention, the population of microbes comprising the microbial mix rapidly expands and results in competitive exclusion of other microbes in the contaminated substrate. Preferably, prior to application, the enzyme blend 12, and microbial mix 13, are gasified using sonic standing waves, however, standing wave or air shear technologies may also be used.

As seen in FIG. 1, biocatalytic method 10, may be combined with a soil vapor extraction (SVE) and/or air sparging system by introduction of the gas phase enzyme blend and microbial mix. In such use, the enzyme blend and the microbial mix are introduced to treatment area 18. Preferably, such a system includes an air sparging well 14, an air vent 16, a vapor extraction well 20, for removal of volatile organic compounds (VOC), and collection reservoir or treatment system 26.

The enzyme blend 12, and microbial mix 13, of biocatalytic method 10, may also be introduced to contaminated water by a hydraulic lift mechanism if desired. Alternatively, enzymatic blend 12, and microbial mix 13, may be introduced or injected into contaminated air held or passed through a reaction chamber.

With reference now to FIG. 2, an air pump 28, with air inflow 30, is operably linked to reservoir 32, containing enzymatic blend 12, and microbial mix 13, preferably in a gaseous state. Both air an the enzymatic blend 12, and microbial mix 13, are introduced or injected into contaminate area 18, via manifold 34, to channels 29. Both enzymatic blend 12, and microbial mix 13, disperse through the contaminated area 18, resulting in the breakdown and digestion of VOC, short, intermediate, and long chain hydrocarbons, and other contaminants in the soil, water, or air.

In FIG. 3, a contaminated area 18, is shown being treated with biocatalytic method 10, by introducing enzymatic blend 12, and microbial mix 13, via channels 29. Vapor extraction well 20, allows for the suction off of gasses for treatment, and air vent 16, for venting air from the system.

In operation and use, the method and apparatus described herein are very inexpensive, effective, and reliable. The method disclosed herein may be used in soil, water, or air, to safely and efficiently remove contaminants. The enzymatic blend 12, and the microbial mix 13, when introduced in a gaseous state, result in the rapid breakdown and digestion of VOC's, short, intermediate, and long chain hydrocarbons, and other contaminants in the soil, water, or air.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A biocatalytic method for remediation and reconditioning of contaminated soil, water, and air, comprising:
(i) introducing enzymatic means for cleaving molecular bonds of contaminants in said soil, water, or air; said enzymatic means being applied in a gaseous phase and being capable of dispersion through the soil, water, or air; and
(ii) introducing microbial means for degradation and digestion of said contaminants in the soil, water, or air; said microbial means being applied in a gaseous phase.

2. The biocatalytic method of claim 1, wherein said enzymatic means are applied in a gaseous phase at ambient temperature.

3. The biocatalytic method of claim 1, wherein said microbial means are applied in a gaseous phase at ambient temperature.

4. The biocatalytic method of claim 1, wherein said enzymatic means comprise a mix of lipase, amylase, protease, cellulose, and pectinase.

5. The biocatalytic method of claim 1, wherein said microbial means comprises a blend of bacillus megaterium, bacillus licheniformis, bacillus subtilis, bacillus thuringenis, and polymyxa.

6. The biocatalytic method of claim 1, wherein said enzymatic means is gasified using sonic standing wave means.

7. The biocatalytic method of claim 1, wherein said microbial means is gasified using sonic standing wave means.

8. The biocatalytic method of claim 1, wherein said enzymatic means are introduced to said contaminated soil by soil vapor extraction (SVE) and sparging means.

9. The biocatalytic method of claim 1, wherein said microbial means are introduced to said contaminated soil by soil vapor extraction (SVE) and sparging means.

10. The biocatalytic method of claim 1, wherein said enzymatic means are introduced to said contaminated water by hydraulic lift means

11. The biocatalytic method of claim 1, wherein said microbial means are introduced to said contaminated water by hydraulic lift means.

12. The biocatalytic method of claim 1, wherein said enzymatic means are introduced to said contaminated air by in a reaction chamber.

13. The biocatalytic method of claim 1, wherein said microbial means are introduced to said contaminated air by in a reaction chamber.

14. A method for remediation and reconditioning of contaminated soil, water, and air, comprising:
(i) injecting enzymatic means for cleaving molecular bonds of contaminants in said soil, water, or air; said enzymatic means being applied in a gaseous phase and being capable of dispersion through the soil, water, or air; and
(ii) injecting microbial means for degradation and digestion of said contaminants in the soil, water, or air; said microbial means being applied in a gaseous phase.

15. The method of claim 14, wherein said enzymatic means are applied in a gaseous phase at ambient temperature.

16. The method of claim 14, wherein said microbial means are applied in a gaseous phase at ambient temperature.

17. The method of claim 14, wherein said enzymatic means comprise a mix of lipase, amylase, protease, cellulase, and pectinase.

18. The method of claim 14, wherein said microbial means comprises a blend of bacillus megaterium, bacillus licheniformis, bacillus subtilis, bacillus thuringenis, and polymyxa.
